(19) United States
(12) Patent Application Publication
(10) Pub. No.: US 2026/0352046 A1
(43) Pub. Date: Nov. 5, 2026

(54) SURFACE-MOUNTED PERMANENT MAGNET SYNCHRONOUS MOTOR USING BAR-TYPE PERMANENT MAGNET

(71) Applicant: SAM HYUN CO., LTD., Changwon-si (KR)

(72) Inventors: Jin HEO, Busan (KR); Woong KIM, Changwon-si (KR); Jin Gyu LEE, Changwon-si (KR); Dong Yeong KIM, Changwon-si (KR); Yun Chang HA, Changwon-si (KR); Duk Hwa KOH, Changwon-si (KR)

(73) Assignee: SAM HYUN CO., LTD., Changwon-si (KR)

(21) Appl. No.: 19/485,682

(22) PCT Filed: Dec. 7, 2023
(86) PCT No.: PCT/KR2023/020107

§ 371 Date: Nov. 19, 2025

(30) Foreign Application Priority Data
Jul. 24, 2023 (KR) 10-2023-0095989

(51) Int. Cl. H02K 1/278; H02K 11/215

(52) U.S. Cl. CPC H02K 1/278; H02K 11/215; H02K 2213/03

(57) ABSTRACT

A surface-mounted permanent magnet synchronous motor using a bar-type permanent magnet includes: a rotor including a rotor core in which a shaft is press-fitted into the central axis thereof, and a permanent magnet which is radially divided with the shaft at the center thereof so as to be attached to the outer circumferential surface of the rotor core and which is formed as a hexahedral bar type; a stator disposed to be spaced a predetermined distance apart from the outer circumferential surface of the permanent magnet; a can covering the rotor; and a sensor magnet formed at the top of the can so as to sense a magnetic field generated by the rotation of the rotor, and thus loss rate is reduced and demagnetization and torque are optimized when processing with the bar-type permanent magnet.

### CROSS REFERENCE TO THE RELATED APPLICATIONS

This application is the national phase entry of International Application No. PCT/KR 2023/020107, filed on Dec. 7, 2023, which is based upon and claims priority to Korean Patent Application No. 10-2023-0095989, filed on Jul. 24, 2023, the entire contents of which are incorporated herein by reference.

### TECHNICAL FIELD

The present disclosure relates to a surface-mounted permanent magnet synchronous motor using a bar-type permanent magnet, which reduces losses and optimizes demagnetization and torque by processing with a bar-type permanent magnet.

### BACKGROUND

The type of a permanent magnet motor can be classified according to the arrangement of a rotor and a stator.

In particular, a surface-mounted permanent magnet (SPM) motor, in which a permanent magnet is attached to the surface of the rotor, generates a sinusoidal counter-electromotive force by attaching the magnet to the surface of a cylindrical shaft, and produces a constant torque when a sinusoidal current is applied to the armature coil, and the SPM can maximize the torque by operating with a maximum q-axis current for maximum torque operation.

For example, referring to FIG. 1, a surface-mounted magnet motor according to the prior art includes a rotor core 110 installed rotatable on the inner side of a stator 12, a plurality of blade-type permanent magnets 120 arranged to be positioned on the outer circumferential surface of the rotor core 110, a plurality of fixing plates 130 for fixing the permanent magnets 120 to the rotor core 110, wherein a plurality of sliding grooves 112 is arranged in a plurality to be formed along the circumference of the outer circumferential surface of the rotor core 110, to be formed vertically along the length direction of the rotor core 110 and to be formed with the width of the inner side larger than the width of the inlet side, such that the fixing plate 130 can be prevented from being detached in the radial direction of the rotor core 110 when combined with the fixing plate 130.

However, when processing the blade-type permanent magnet as described above, there are problems of increasing the cost since there is an area unnecessarily removed to form an arc structure and of requiring additional process costs since accompanying a process of manufacturing and assembling a separate fixing plate.

Accordingly, there is a need for a technology capable of reducing losses by processing with a bar-type permanent magnet.

Related Art Documents
(Patent Document 1) Korean Patent Application Publication No. 10-2007-0113726
(Patent Document 2) Korean Patent No. 10-1302511

### SUMMARY

### Technical Problem

A technical task to be achieved by the idea of the present disclosure is to provide a surface-mounted permanent magnet synchronous motor using a bar-type permanent magnet, which reduces losses and optimizes demagnetization and torque by processing with a bar-type permanent magnet.

### Technical Solution

To achieve the aforementioned objective, an exemplary embodiment of the present disclosure provides a surface-mounted permanent magnet synchronous motor using a bar-type permanent magnet, which includes a rotor composed of a rotor core with a shaft press-fitted into a central axis and a permanent magnet formed in a hexahedral bar type which is radially divided around the shaft and attached to an outer circumferential surface of the rotor core, a stator disposed to be spaced apart at a predetermined distance from the outer circumferential surface of the permanent magnet, a can covering the rotor, and a sensor magnet formed on an upper end of the can to detect a magnetic field generated by a rotation of the rotor.

Herein, with respect to the central axis of the rotor core, a ratio (a/B) of an arc angle (a) of a length (A) of a second side of the permanent magnet facing the stator to an arc angle (B) of a length (B) of a first side of the permanent magnet facing the rotor core may be in the range of 0.91 to 0.92.

In addition, a corner of the permanent magnet is rounded with a constant radius of curvature, and the lengths of the first side (B) and the second side (A) may be a length defined before a rounding process is performed.

In addition, a ratio of (B/A) may be in the range of 0.98 to 1.02.

In addition, a ratio (T/A) of a thickness (T) of the permanent magnet to the length (A) of the second side may be in the range of 0.22 to 0.26.

In addition, the can may be formed by an insert injection molding method in which a resin is overmolded onto the rotor.

In addition, the sensor magnet may be fixed in position within an insert injection molding mold and may be molded so as to be formed inside the can.

### Advantageous Effects

According to the present disclosure, there is an effect of lowering the cost by reducing losses when processing with a bar-type permanent magnet by wire cutting, of optimizing the demagnetization and torque by reducing the thickness after securing the appropriate torque of the permanent magnet, and of reinforcing the rigidity of the rotor through insert injection of the can.

### BRIEF DESCRIPTION OF THE DRAWINGS

FIG. 1 is a view illustrating a surface-mounted permanent magnet synchronous motor according to the related art.

FIGS. 2A-2B are views illustrating a surface-mounted permanent magnet synchronous motor using a bar-type permanent magnet according to an exemplary embodiment of the present disclosure.

FIG. 3 is a view illustrating a cross-sectional structure of a surface-mounted permanent magnet synchronous motor using a bar-type permanent magnet of FIGS. 2A-2B.

FIG. 4 is a view of an example in which a partial portion of a planar structure of a surface-mounted permanent magnet synchronous motor using a bar-type permanent magnet of FIGS. 2A-2B is isolated.

FIGS. 5A-5B are views illustrating a demagnetization analysis graph of a surface-mounted permanent magnet synchronous motor using a bar-type permanent magnet of FIGS. 2A-2B.

FIG. 6 is a table illustrating a minimum magnetic flux density of a permanent magnet for changes in a/ß based on experiments conducted on a surface-mounted permanent magnet synchronous motor using a bar-type permanent magnet of FIGS. 2A-2B.

FIG. 7 is a table illustrating a counter-electromotive force and cogging torque for a magnet grade and thickness based on experiments conducted on a surface-mounted permanent magnet synchronous motor using a bar-type permanent magnet of FIGS. 2A-2B.

FIGS. 8A-8C are views illustrating an implemented example of a surface-mounted permanent magnet synchronous motor using a bar-type permanent magnet of FIGS. 2A-2B.

### DESCRIPTION OF REFERENCE NUMERALS

110: rotor
111: shaft
112: rotor core
113: permanent magnet
114: rotor core support
120: stator
130: can
140: sensor magnet

### DETAILED DESCRIPTION OF THE EMBODIMENTS

Hereinafter, an exemplary embodiment of the present disclosure having the above-described features will be described in more detail with reference to the accompanying drawings.

A surface-mounted permanent magnet synchronous motor using a bar-type permanent magnet according to an exemplary embodiment of the present disclosure may include a rotor 110 composed of a rotor core 112 in which a shaft 111 is press-fitted into a central axis, and a permanent magnet 113 formed in a hexahedral bar type which is radially divided around the shaft and attached to an outer circumferential surface of the rotor core, a stator 120 disposed to be spaced apart at a predetermined distance from an outer circumferential surface of the permanent magnets 113, a can 130 covering the rotor 110, and a sensor magnet 140 formed on an upper end of the can 130 to detect a magnetic field generated by a rotation of the rotor 110, thereby reducing losses when processing with the bar-type permanent magnet 113 and optimizing demagnetization and torque.

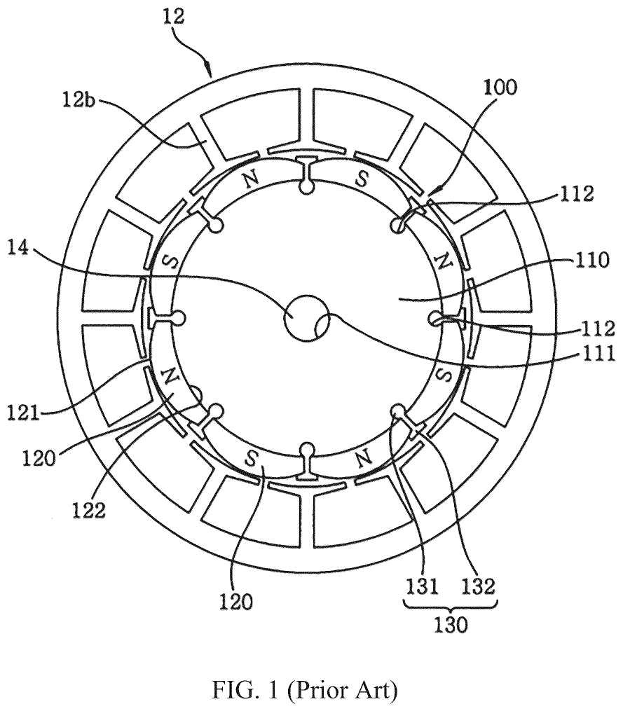

Hereinafter, the surface-mounted permanent magnet synchronous motor using the bar-shaped permanent magnet having the above-described configuration will be described in detail with reference to FIGS. 1-8C.

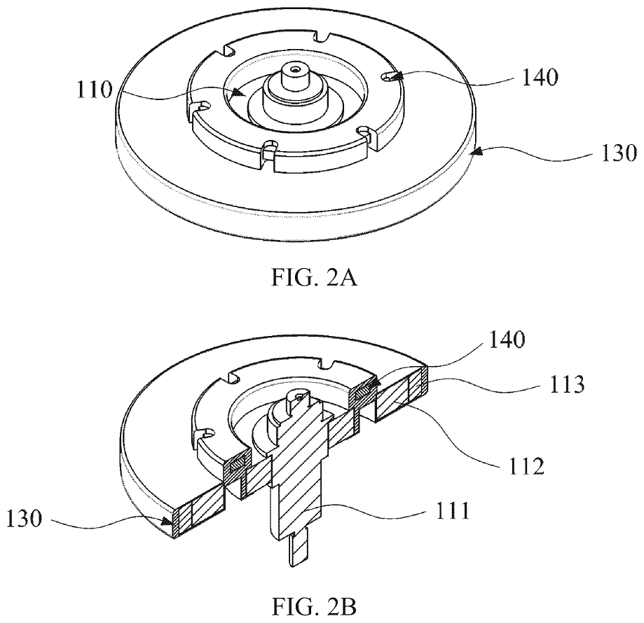

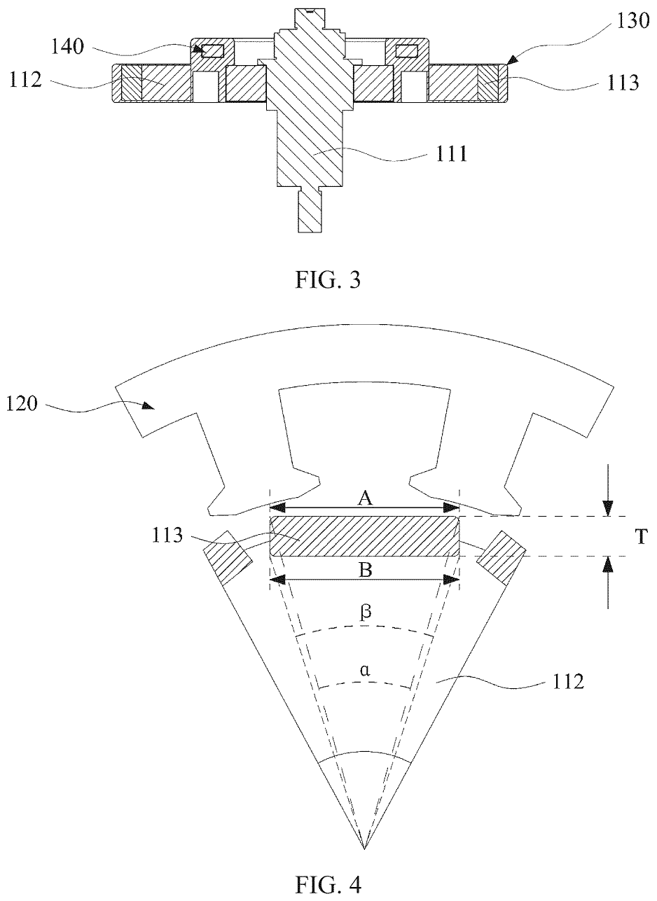

First, as shown in FIGS. 2A-3, the rotor 110 may include a rotor core 112 in which a shaft 111 is press-fitted at a central axis, and a permanent magnet 113 formed in a hexahedral bar type, which is radially divided around the shaft 111 and attached to the outer circumferential surface of the rotor core 112.

Herein, the permanent magnet 113 may be formed into a bar type through wire cutting, thereby lowering manufacturing cost by reducing the amount of loss during processing.

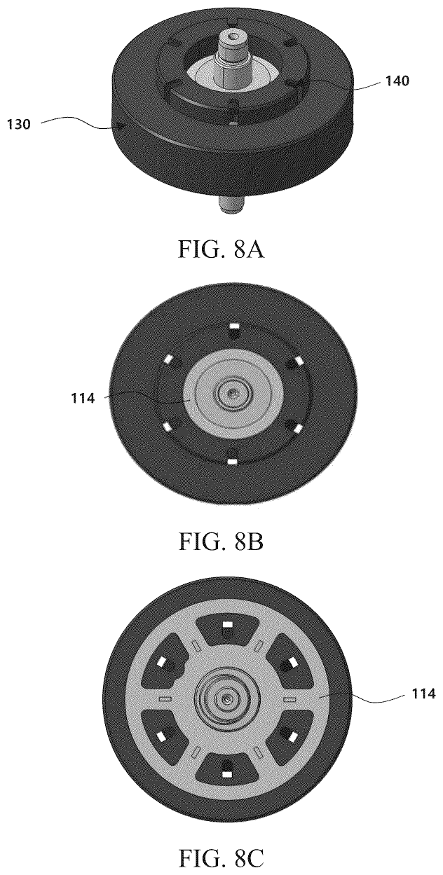

Meanwhile, referring to FIGS. 8A-8C, a rotor core support 114 may be coupled to a lower surface and an upper surface of the rotor core 112.

Next, referring to FIG. 4, the stator 120 may be disposed to be spaced apart at a predetermined distance from the outer circumferential surface of the bar-type permanent magnet 113.

Meanwhile, referring to FIG. 4, with respect to the central axis of the rotor core 112, it is preferable that the ratio (a/B) of the arc angle (a) of the length (A) of the second side of the permanent magnet 113 facing the stator 120 to the arc angle (B) of the length (B) of the first side of the permanent magnet 113 facing the rotor core 112 is in the range of 0.91 to 0.92.

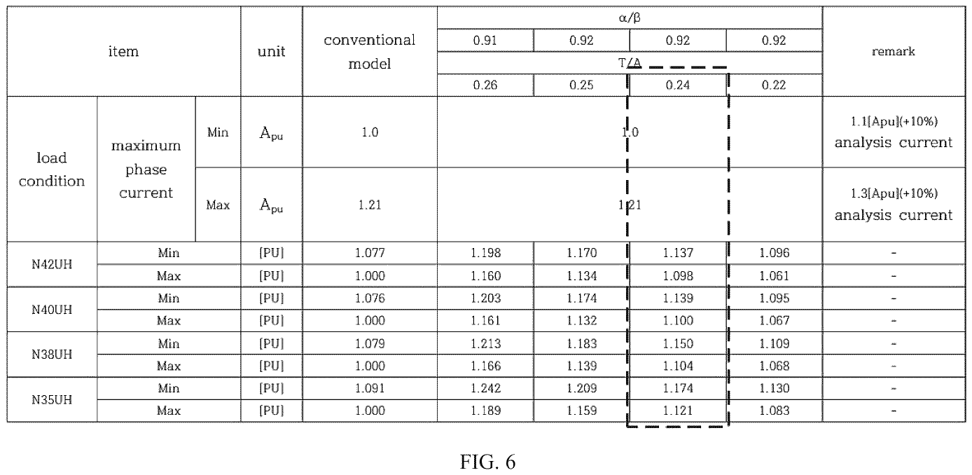

In addition, referring to FIG. 6, when the ratio (a/B) is less than 0.91, the magnetic flux density value may increase but the thickness (T) and width of the permanent magnet may increase, thereby resulting in higher manufacturing cost, and when the ratio (a/B) exceeds 0.92, the thickness (T) and width of the permanent magnet 113 may decrease, thereby reducing manufacturing cost, but the magnetic flux density value may decrease, such that it is preferable that the ratio (a/B) is in the range of 0.91 to 0.92.

In addition, when the thickness (T) of the permanent magnet 113 is less than 1.9 mm, the manufacturing cost can be reduced but the magnetic flux density value may decrease, and when the thickness (T) exceeds 2.1 mm, the magnetic flux density value may increase but the manufacturing cost may also increase, such that it is preferable that the thickness (T) is in the range of 1.9 mm to 2.1 mm.

Herein, FIG. 4 illustrates the shape of a permanent magnet of a synchronous motor having 14 poles and 12 slots for an automobile component to which the present exemplary embodiment is applied, and the ratio (a/B) can be adjusted to optimize demagnetization resistance and torque.

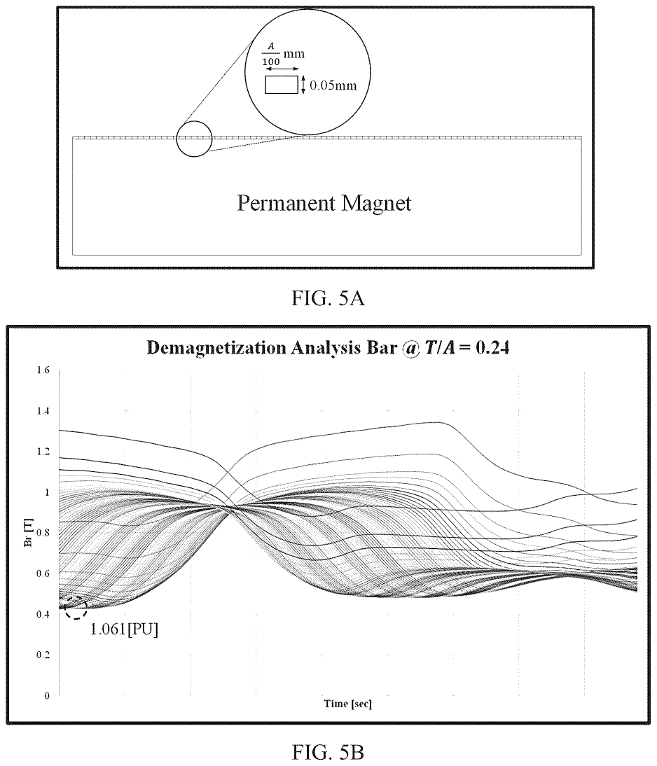

That is, whether irreversible demagnetization occurs can be confirmed through a demagnetization analysis, for the magnetic demagnetization analysis, 100 points selected with a magnet width of (A/100) mm and a thickness of 0.05 mm may be generated, and FIGS. 5A-5B illustrate the analysis results of the residual magnetic flux density value at each point during one electric-angle cycle of the bar-type permanent magnet when the ratio of (T/A) is 0.24, such that it can be confirmed that the minimum magnetic flux density value is 1.061 [PU] based on the maximum demagnetization rate, and the occurrence of magnetic demagnetization can be verified through the corresponding operating point of the permanent magnet.

For reference, an irreversible demagnetization may refer to a phenomenon in which the permanent magnet cannot recover to its original operating point after passing the knee point of the magnetic demagnetization curve due to the influence of an external magnetic field, and local demagnetization of the permanent magnet may occur as a result of a short-circuit current or excessive current, which causes the operating point to change.

Meanwhile, the table shown in FIG. 6 presents analysis results of the minimum magnetic flux density of the permanent magnets with respect to the permanent magnet shape, permanent magnet grade, and the ratio (a/B), and when the ratio (a/B) of the permanent magnet is adjusted to be in the range of 0.91 to 0.92, it can be seen that the permanent magnet having a thickness (T) corresponding to a ratio of (T/A) in the range of 0.22 to 0.26 exhibits sufficient demagnetization resistance compared to a conventional blade-type model.

That is, when the ratio of (T/A) is less than 0.22, the magnetic flux density value may decrease sharply, and when the ratio of (T/A) exceeds 0.26, the thickness (T) of the permanent magnet may increase, resulting in a rapid rise in the manufacturing cost, such that it is preferable that the ratio of (T/A) is in the range of 0.22 to 0.26.

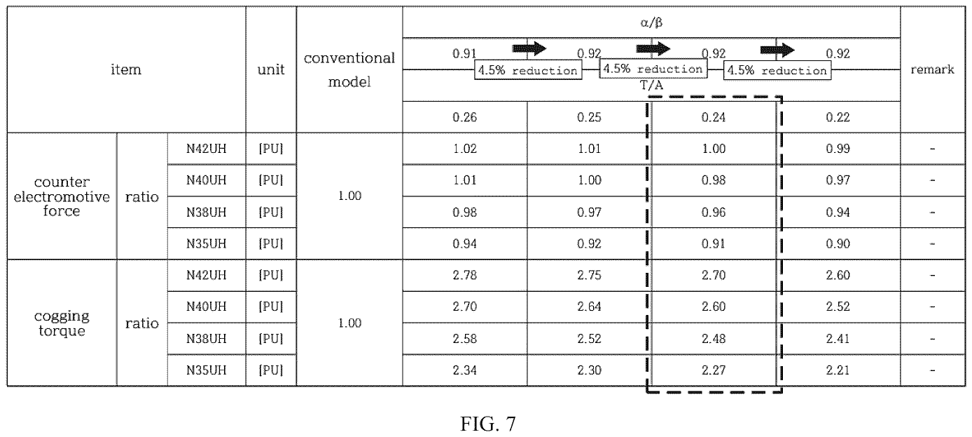

In addition, FIG. 7 illustrates the counter electromotive force and cogging torque for the magnet grade and thickness of the bar-type permanent magnet when the ratio of (a/B) ranges from 0.91 to 0.92, and when considering only the models in which the counter electromotive force is 1.0 or higher, it is confirmed that the cost reduction rate obtained by increasing the thickness of the permanent magnet is 4.5%, which is greater than the 3% reduction rate obtained by changing the magnet grade, such that a N42UH permanent magnet model having a thickness (T) corresponding to a ratio of (T/A) in the range of 0.22 to 0.26 may be preferable and a cost reduction of about 9% may be possible by adjusting the thickness of the permanent magnet.

In addition, as described above, it is preferable that the thickness (T) of the permanent magnet 113 satisfies the relational expression of {(T/A)=0.22 to 0.26}.

In addition, as illustrated in FIG. 4, the corners of the permanent magnet 113 may be rounded with a certain radius of curvature, and the length (B) of the first side and the length (A) of the second side may be lengths defined before the round processing is performed, and it is desirable that the ratio of (B/A) be in the range of 0.98 to 1.02, which is the allowable processing error range of the permanent magnet 113 during processing.

This is because, within the corresponding range, the permanent magnet 113 has an approximately rectangular parallelepiped shape, so that material loss can be minimized during processing, but, beyond the range, it has a trapezoidal shape, so that although its magnetic flux density value is identical or similar to that of a rectangular parallelepiped magnet, unnecessary material loss can occur.

Next, referring to FIGS. 2A-3, the can 130 may cover the rotor 110, especially the permanent magnet 113, thereby preventing from falling off during rotation.

That is, the can 130 may be formed by an insert injection molding method in which a resin is overmolded onto the rotor 110, and after the permanent magnets 113 are bonded and attached to the outer circumferential surface of the rotor core 112, the rotor core 112 and the permanent magnets 113 may be positioned in an insert injection molding mold and overmolded with resin without an assembly process of a magnet protector, such that the can 130 can improve the rigidity of the rotor 110 by preventing the permanent magnet 113 from being separated from the rotor core 112 when the rotor 110 rotates.

Next, referring to FIGS. 2A-3, the sensor magnet 140 may be formed at the upper end of the can 130 and may detect a magnetic field generated by the rotation of the rotor 110.

Herein, the sensor magnet 140 may be fixed in position within the above-mentioned insert injection molding mold and may be molded so as to be formed inside the can 130.

That is, similar to the permanent magnet 113, the sensor magnet 140 may be formed on the upper end of the can 130 by an insert injection molding method in which resin is overmolded without a press-fitting process after bonding a sensor holder and may be prevented from separating from the rotor core 112 when the rotor 110 rotates, thereby improving the rigidity of the rotor 110.

Accordingly, with the configuration of the surface-mounted permanent magnet synchronous motor using the bar-type permanent magnet as described above, it is possible to lower the cost by reducing losses when processing with the bar-type permanent magnet by wire cutting, to optimize the demagnetization and torque by reducing the thickness after securing the appropriate torque of the permanent magnet, and to reinforce the rigidity of the rotor through insert injection of the can.

Since the exemplary embodiments described in the present specification and the configurations illustrated in the drawings may be merely exemplary of the most preferred exemplary embodiment of the present disclosure and do not represent all of the technical ideas of the present disclosure, it should be understood that there are various equivalents and modifications capable of substituting the exemplary embodiments at the time of filing of the present application.

What is claimed is:

1. A surface-mounted permanent magnet synchronous motor using a bar-type permanent magnet, comprising:
a rotor comprising a rotor core with a shaft press-fitted into a central axis of the rotor core and a permanent magnet formed in a hexahedral bar type, wherein the permanent magnet is radially divided around the shaft and attached to an outer circumferential surface of the rotor core;
a stator disposed to be spaced apart at a predetermined distance from an outer circumferential surface of the permanent magnet;
a can covering the rotor; and
a sensor magnet formed on an upper end of the can to detect a magnetic field generated by a rotation of the rotor.

2. The surface-mounted permanent magnet synchronous motor of claim 1, wherein with respect to the central axis of the rotor core, a ratio of an arc angle of a length of a second side of the permanent magnet facing the stator to an arc angle of a length of a first side of the permanent magnet facing the rotor core is in a range of 0.91 to 0.92.

3. The surface-mounted permanent magnet synchronous motor of claim 2, wherein a corner of the permanent magnet is rounded with a constant radius of curvature, and the length of the first side and the length of the second side are a length defined before a rounding process is performed.

4. The surface-mounted permanent magnet synchronous motor of claim 3, wherein a ratio of the length of the first side to the length of the second side is in a range of 0.98 to 1.02.

5. The surface-mounted permanent magnet synchronous motor of claim 3, wherein a ratio of a thickness of the permanent magnet to the length of the second side is in a range of 0.22 to 0.26.

6. The surface-mounted permanent magnet synchronous motor of claim 1, wherein the can is formed by an insert injection molding method, wherein in the insert injection molding method, a resin is overmolded onto the rotor.

7. The surface-mounted permanent magnet synchronous motor of claim 6, wherein the sensor magnet is fixed in position within an insert injection molding mold, and the sensor magnet is molded to be formed inside the can.
